(19) United States
(12) Patent Application Publication
(10) Pub. No.: US 2026/0119570 A1
(43) Pub. Date: Apr. 30, 2026

(54) INFORMATION PROCESSING SYSTEM, METHOD OF CONTROLLING INFORMATION PROCESSING SYSTEM, AND RECORDING MEDIUM

(71) Applicant: CANON KABUSHIKI KAISHA, Tokyo (JP)

(72) Inventor: KAZUNARI KUROKAWA, Kanagawa (JP)

(21) Appl. No.: 19/367,579

(22) Filed: Oct. 23, 2025

(30) Foreign Application Priority Data
Oct. 30, 2024 (JP) 2024-190749

(51) Int. Cl. G06F 16/535; G06F 16/532; G06T 3/40; G06T 11/40; G06V 30/418; G06V 30/422

(52) U.S. Cl. CPC G06F 16/535; G06F 16/532; G06T 3/40; G06T 11/40; G06V 30/418; G06V 30/422

(57) ABSTRACT

An information processing system includes an acquisition unit configured to acquire a first image generated from a retrieval image and a second image as a silhouette image generated from the retrieval image, and a calculation unit configured to calculate a similarity between the retrieval image and each of a plurality of registered images by comparing the first image and the second image acquired by the acquisition unit with each of the plurality of registered images. A similar image can be retrieved with high reliability by calculating the similarity as described above, even when an image has a contour shape drawn by lines.

### BACKGROUND

### Field of the Technology

The present disclosure relates to an information processing system, a method of controlling the information processing system, and the like.

### Description of the Related Art

Image retrieval for retrieving a similar image from images accumulated in the past is performed in various fields. Such image retrieval can be applied to, for example, a field of design and manufacture of a member such as a mold. In the field of design and manufacture of the member such as a mold, past results of similar cases are used as reference in estimation of a cost and time and effort for mold manufacture, but similarity determination is often manually performed using drawings of the members in the past. Such similarity determination is difficult unless a person is an expert because similarity determination requires a high skill and experience.

For this reason, various mechanisms for retrieving a similar image with high accuracy from accumulated images by using an image as a retrieval query have been proposed. Japanese Patent Application Laid-Open No. 2020-173640 describes a method in which a first hash value and a second hash value different in length from each other are calculated for each of registered images and a query image, the hash values of each of the registered images and the hash values of the retrieval query image are compared to retrieve a similar image.

In a design drawing of a member such as a mold, a contour shape including concave and convex parts drawn by lines is used. The method described in Japanese Patent Application Laid-Open No. 2020-173640 may not be able to correctly specify the image having such a contour shape as a similar image.

### SUMMARY

The present disclosure is directed to providing a high-reliability similar image retrieval method that enables retrieval of a similar image even when an image has a contour shape drawn by lines.

According to embodiments of the present disclosure, an information processing system includes an acquisition unit configured to acquire a first image generated from a retrieval image and a second image as a silhouette image generated from the retrieval image, and a calculation unit configured to calculate a similarity between the retrieval image and each of a plurality of registered images by comparing the first image and the second image acquired by the acquisition unit with each of the plurality of registered images.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram illustrating a configuration of an information processing system including an image retrieval server according to embodiments of the present disclosure, and FIG. 1B is a diagram illustrating a hardware configuration according to the embodiments of the present disclosure.

FIG. 2 is a flowchart illustrating a flow of registration processing in an information processing system according to a first embodiment.

FIG. 3A is a diagram illustrating necessity of a silhouette image, and FIG. 3B is a diagram illustrating image processing for generating a resized image and a silhouette image from an input image.

FIG. 4A is a diagram illustrating a method of extracting an image used for image registration, and FIG. 4B is a diagram illustrating registration processing.

FIG. 5A illustrates an example of a data table in which a feature amount of the resized image is registered, and FIG. 5B illustrates an example of a data table in which a feature amount of the silhouette image is registered.

FIG. 6 is a diagram illustrating a flow of processing for retrieving a similar drawing in the information processing system according to the first embodiment.

FIG. 7 is a diagram illustrating the flow of the processing for retrieving the similar drawing in the information processing system according to the first embodiment.

FIG. 8A is a diagram illustrating a case where the resized image is more important than the silhouette image, and FIG. 8B illustrates an example of a data table used for weighting.

FIG. 9A is a diagram illustrating extraction of an image used for retrieval processing, and FIG. 9B is a diagram illustrating the retrieval processing.

FIG. 10 illustrates an example of a data table in which a distance with the retrieval image is registered.

FIG. 11 illustrates an example of a data table in which registered drawings are sorted in an order of similarity with a retrieval drawing.

FIG. 12A illustrates an example of the retrieval drawing, and FIG. 12B illustrates an example of a method of displaying a retrieval result specified in the retrieval processing.

FIG. 13A is a diagram illustrating a method of determining a weight coefficient according to a second embodiment, and FIG. 13B illustrates an example of a data table used for determining the weight coefficient according to the second embodiment.

### DESCRIPTION OF THE EMBODIMENTS

An information processing system, a method of controlling the information processing system, and the like according to embodiments of the present disclosure are described with reference to drawings. The embodiments described below are illustrative, and for example, detailed configurations can be appropriately changed by those skilled in the art without departing from the gist of the present disclosure.

In the drawings referred in description of the embodiments and modifications, elements denoted by the same reference numerals have a similar function unless otherwise noted. In the drawings, in a case where a plurality of same elements is arranged, reference numerals and descriptions of the elements may be omitted.

Further, there is a case where the drawings are schematically represented for convenience of illustration and description. Therefore, shapes, sizes, arrangement, and the like of elements illustrated in the drawings may not be exactly coincident with actual elements.

### First Embodiment

### (Information Processing System)

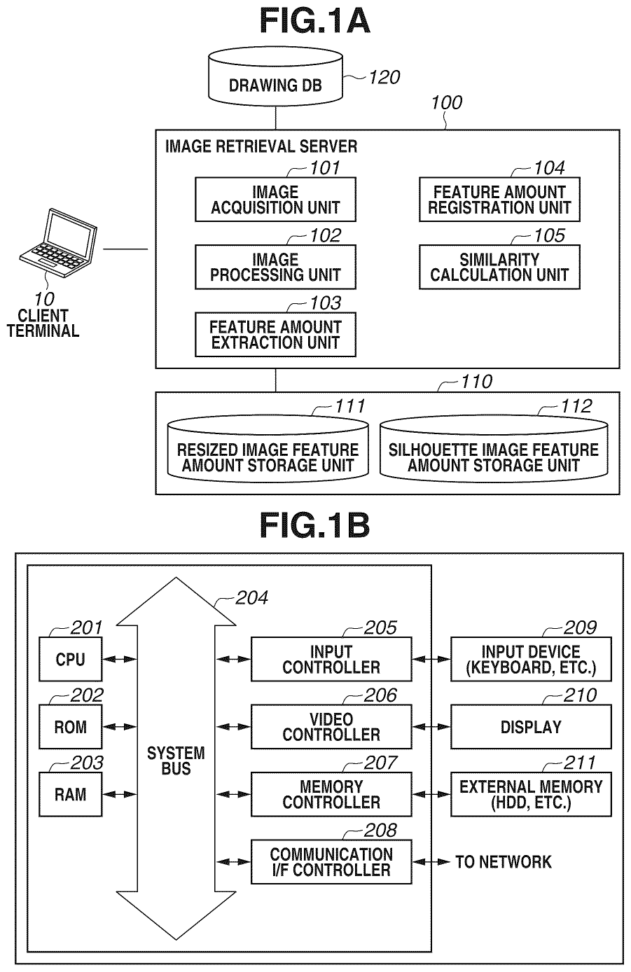

FIG. 1A illustrates a configuration of an information processing system including an information processing apparatus according to a first embodiment. The information processing system includes a client terminal 10, an image retrieval server 100, a storage unit 110, and a drawing database (DB) 120.

The drawing DB 120 can store drawings of parts such as a mold manufactured in the past, and design information, cost information, and the like corresponding to the drawings. In the present embodiment, the drawings stored in the drawing DB 120 are used as registered drawings. In the present embodiment, a case where drawings of molds used for plastic injection molding are stored in the drawing DB 120, and a similar drawing similar to a retrieval drawing is extracted from the drawing DB 120 is described as an example. Each of the drawings includes plan views of a mold as viewed from a plurality of directions, and image retrieval is performed using such plan views.

The storage unit 110 includes a resized image feature amount storage unit 111 and a silhouette image feature amount storage unit 112 that are referred to during retrieval processing.

The client terminal 10 is a terminal operated by a user, and can issue a drawing display instruction, and an image extraction instruction, display a result, a similar drawing, and the like.

The image retrieval server 100 functions as a registration processing unit and a retrieval processing unit, and includes functional block units such as an image acquisition unit 101, an image processing unit 102, a feature amount extraction unit 103, a feature amount registration unit 104, and a similarity calculation unit 105.

The image acquisition unit 101 is an acquisition unit for acquiring an image instructed to be extracted by the client terminal 10.

The image processing unit 102 is a processing unit for generating a resized image and a silhouette image from the acquired image.

The feature amount extraction unit 103 extracts a feature amount from each of the generated resized image and the generated silhouette image.

The feature amount registration unit 104 stores the extracted feature amounts as index information in the resized image feature amount storage unit 111 and the silhouette image feature amount storage unit 112 of the storage unit 110.

The similarity calculation unit 105 calculates (determines) a similarity between the retrieval image/drawing and the registered image/drawing by using the information stored in the storage unit 110 and the information extracted from the retrieval image by the feature amount extraction unit 103.

FIG. 1B is a diagram illustrating an example of a hardware configuration of the client terminal 10 and the image retrieval server 100. A central processing unit (CPU) 201 totally controls devices and controllers connected to a system bus 204.

A read only memory (ROM) 202 or an external memory 211 stores a basic input/output system (BIOS) and an operating system program (OS) that are control programs of the CPU 201 and various kinds of programs necessary for realizing functions.

A random access memory (RAM) 203 functions as a main memory, a work area, and the like for the CPU 201.

The CPU 201 loads programs and the like necessary for execution of processing to the RAM 203, and executes the programs to realize various kinds of operation.

An input controller (input C) 205 controls input from an input device 209 such as a keyboard and a pointing device like a mouse (not illustrated).

A video controller (VC) 206 controls display on a display terminal such as a display 210. As a type of the display terminal, a cathode-ray tube (CRT) and a liquid crystal display are assumed, but the type of the display terminal is not limited to these examples.

A memory controller (MC) 207 controls access to a hard disk (HD), a flexible disk (FD), and the external memory 211 connected to a Personal Computer Memory Card International Association (PCMCIA) card slot through an adapter. A boot program, browser software, various kinds of applications, font data, user files, edit files, various kinds of data, and the like are stored in the hard disk and the flexible disk.

A communication interface (I/F) controller (communication I/FC) 208 is connected to and communicates with an external apparatus through a network, and performs communication control processing via the network. For example, internet communication using transmission control protocol/internet protocol (TCP/IP) can be performed.

The CPU 201 can display an outline font on the display 210 by, for example, performing processing for developing (rasterizing) the outline font into a display information region in the RAM 203.

Further, the CPU 201 allows a user to issue instructions by using a mouse cursor (not illustrated) and the like on the display 210.

In the client terminal 10 and the image retrieval server 100 according to the present embodiment, various kinds of programs and the like used for performing various kinds of processing are recorded in the external memory 211, are loaded to the RAM 203 as necessary, and are executed by the CPU 201. Further, definition files and various kinds of information tables used by the programs according to the present embodiment can also be stored in the external memory 211.

### (Feature Amount Registration Processing)

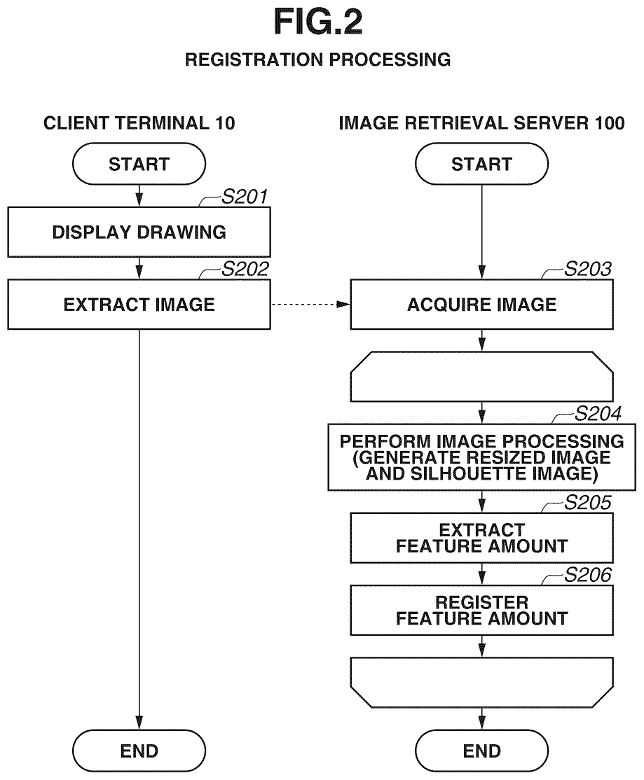

A flow of feature amount registration processing by the information processing system is described with reference to a flowchart illustrated in FIG. 2. Processing illustrated in the flowchart is realized when the CPU 201 reads out and executes the stored control programs.

In step S201, the CPU 201 of the client terminal 10 displays a drawing (registered drawing) stored in the drawing DB 120. In step S202, the CPU 201 of the client terminal 10 receives an image extraction instruction from the user on the displayed drawing, and then transmits information on the extracted image to the image retrieval server 100. At this time, the user can issue extraction instructions for extracting a plurality of images from one drawing. To extract an image, the user may manually designate a range to extract the image as described above, or automatic shape extraction using machine learning may be performed. In the present embodiment, an example in which the extraction work is performed on the client terminal 10 is described, but the extraction work may be performed on the image retrieval server 100.

In step S203, the CPU 201 of the image retrieval server 100 acquires the extracted image (registered image) from the client terminal 10.

In step S204, the CPU 201 of the image retrieval server 100 generates a resized image and a silhouette image used to extract feature amounts from the extracted image (registered image). A size of the extracted image is not constant in aspect ratio. Accordingly, resizing processing is performed to generate a resized image having a predetermined vertical/horizontal size such that a vertical resolution and a horizontal resolution become constant. In other words, depending on the size of the extracted image, the resizing processing in which magnification is different between the vertical direction and the horizontal direction is performed.

The reason why the resizing processing is performed is to extract feature amounts of the same size from each of all images in subsequent processing for extracting the feature amounts. In other words, the vertical/horizontal size of the image is previously adjusted in order to extract feature amounts of the same size, which makes it possible to determine a similarity between the images from comparison of the feature amounts. The resizing processing may not be performed as long as the images are extracted so as to have a predetermined vertical/horizontal size. The silhouette image is an image generated by painting an inside of an outermost contour of the extracted image.

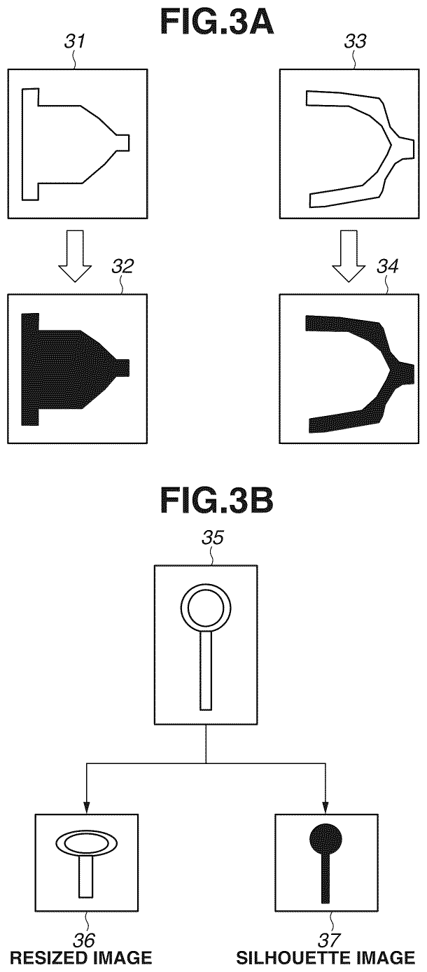

Necessity of the silhouette image is described with reference to FIG. 3A. An image 31 and an image 33 are examples of a contour shape drawn only by lines, and it seems like the image 31 and the image 33 are not similar to each other at the first glance.

However, depending on a type of a similarity determination method, it is not possible to correctly determine concave and convex parts of the contour shapes of the image 31 and the image 33, and it may be determined that the image 31 and the image 33 are similar to each other. On the other hand, in each of a silhouette image 32 generated from the image 31 and a silhouette image 34 generated from the image 33, an inside of the contour shape is clear, and it is possible to correctly determine the concave and convex parts as a whole of the shape, and to determine that the image 31 and the image 33 are not similar even by the above-described method. However, in a case of images internally including a feature shape, it is not possible to correctly determine a similarity only from the silhouette images. Accordingly, in the present embodiment, the resized image and the silhouette image generated from the same image are both used to correctly specify a similar drawing.

FIG. 3B is a diagram illustrating image generation processing performed in step S204. In a case where the image acquisition unit 101 acquires a registered image 35, the image processing unit 102 can perform image processing on the registered image 35 to generate a resized image 36 resized to have a predetermined size and a silhouette image 37 obtained by silhouetting the registered image 35.

In step S205, the CPU 201 of the image retrieval server 100 extracts (generates) a feature amount from each of the resized image and the silhouette image. The feature amount is a numerical value of features of an object image. In the present embodiment, a one-dimensional numerical array can be used as the feature amount.

In step S206, the CPU 201 of the image retrieval server 100 stores the feature amount extracted from the resized image in step S205, in the resized image feature amount storage unit 111, and stores the feature amount extracted from the silhouette image in the silhouette image feature amount storage unit 112. In a case where a plurality of extracted images is acquired in step S203, the processing in steps S204 to S206 is repeatedly performed until the feature amounts of all images are registered.

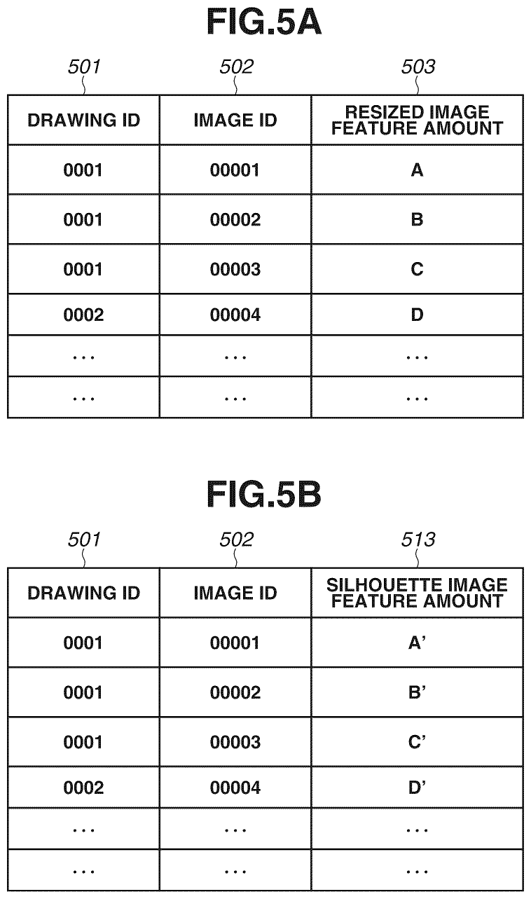

FIG. 5A illustrates an example of a data table when the feature amount is stored in the resized image feature amount storage unit 111. A drawing identification (ID) 501 that is an extraction source of the registered image 35, an image ID 502 of the registered image 35, and a resized image feature amount 503 extracted from the image having the corresponding image ID are registered.

FIG. 5B illustrates an example of a data table when the feature amount is stored in the silhouette image feature amount storage unit 112. The drawing ID 501 that is the extraction source of the registered image 35, the image ID 502 of the registered image 35, and a silhouette image feature amount 513 extracted from the image having the corresponding ID are registered.

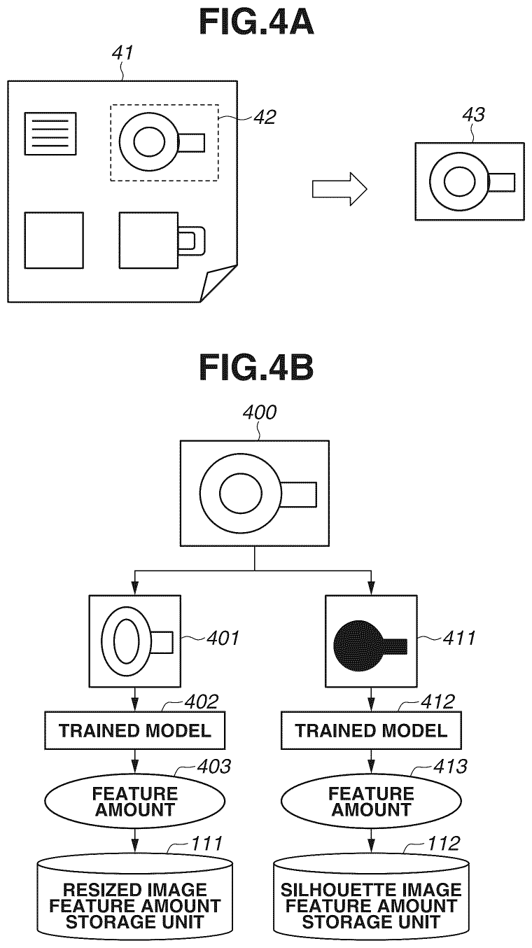

FIG. 4A is a diagram illustrating a method of extracting an image used for image registration in step S202. For example, the user displays a drawing 41 stored in the drawing DB 120, on a display terminal of the client terminal 10, and designates a selection range 42 to extract a registered image 43. Next, a flow of the feature amount registration processing performed in steps S204 to S206 is described with reference to FIG. 4B. A resized image 401 is an image obtained by resizing a registered image 400 to have a resolution of 224×224 pixels. A silhouette image 411 is obtained by resizing the registered image 400 to have a resolution of 224×224 pixels while keeping the aspect ratio of the registered image 400, and painting the inside of the outermost contour. The feature amounts can be extracted using trained models 402 and 412. As the trained models to be used, a well-known neural network in which convolutional neural networks (CNNs) are stacked, such as visual geometry group (VGG) and residual neural network (ResNet) can be used.

A feature amount 403 extracted from the resized image 401 and a feature amount 413 extracted from the silhouette image 411 are values respectively output from the trained models 402 and 412, and are output as, for example, one-dimensional numerical arrays. A value of the feature amount of the resized image and a value of the feature amount of the silhouette image can be separately registered. The similarity determination is smoothly performed when a weight is entirely applied to the resized image. For this reason, the array of the feature amount of the resized image can be set to 1024, and the array of the feature amount of the silhouette image can be set to 512.

When the feature amounts corresponding to a large number of image IDs are previously stored in the resized image feature amount storage unit 111 and the silhouette image feature amount storage unit 112, similar drawing retrieval processing described below can be smoothly performed. In the present embodiment, the example in which the registration work is performed from the drawing previously registered in the drawing DB 120 is described, but when a drawing is registered in the drawing DB 120, feature amounts of an image included in the drawing may be automatically registered in the storage unit 110.

### (Similar Drawing Retrieval Processing)

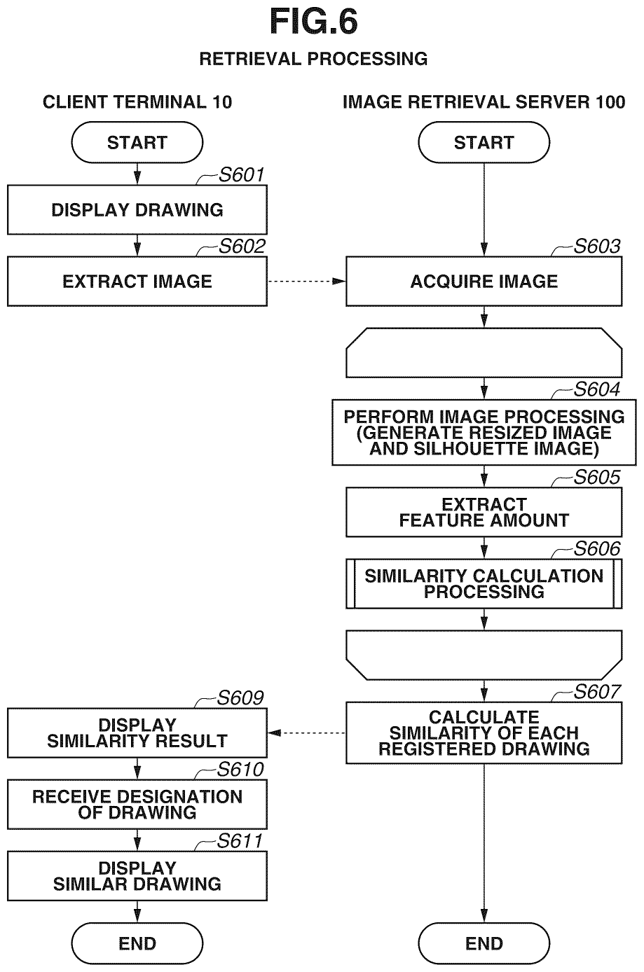

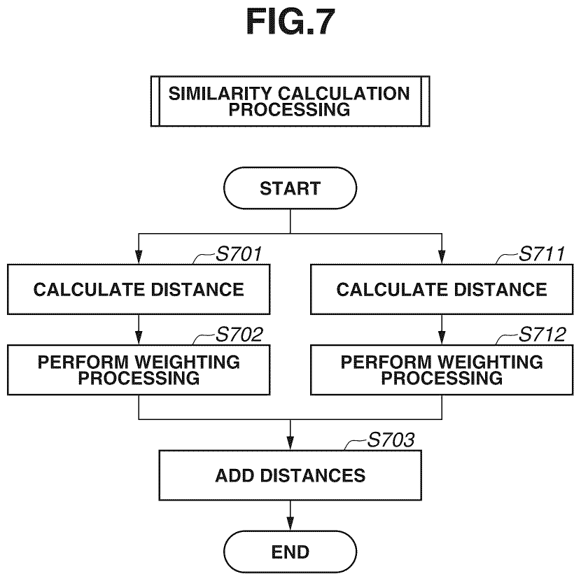

Next, the retrieval processing for retrieving a registered drawing similar to the retrieval drawing as a retrieval object from the drawings stored in the drawing DB 120 by the information processing system is described with reference to flowcharts illustrated in FIG. 6 and FIG. 7. Processing illustrated in the flowcharts is realized when the CPU 201 reads out and executes the stored control programs. A part of the processing is similar to the processing in the flowchart illustrated in FIG. 2, and accordingly, description of such processing is omitted.

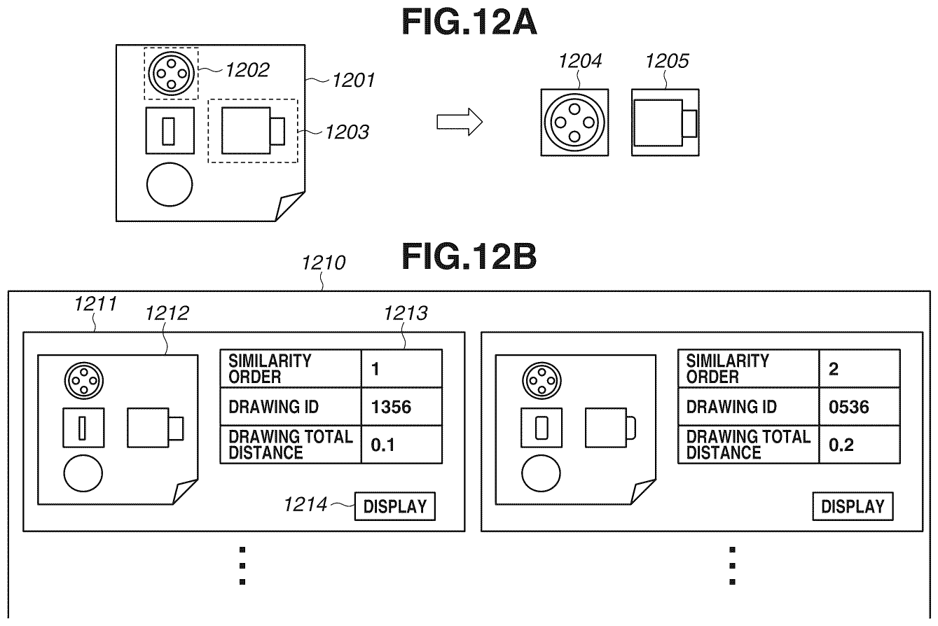

In step S601, the CPU 201 of the client terminal 10 displays the retrieval drawing. In step S602, the CPU 201 of the client terminal 10 receives an image extraction instruction from the user on the displayed drawing, and then transmits information on the extracted image to the image retrieval server 100. At this time, the user can issue extraction instructions for extracting a plurality of images from one drawing. FIG. 12A is a diagram illustrating a method of extracting a retrieval image used for the retrieval processing. The user displays a retrieval drawing 1201 on a screen of the client terminal 10, and designates selection ranges 1202 and 1203 to extract retrieval images 1204 and 1205.

In step S603, the CPU 201 of the image retrieval server 100 acquires the extracted image (retrieval image) from the client terminal 10.

In step S604, the CPU 201 of the image retrieval server 100 generates a resized image (first image) and a silhouette image (second image) used to extract feature amounts from the extracted image (retrieval image). In step S605, the CPU 201 of the image retrieval server 100 extracts (generates) a feature amount from each of the resized image (first image) and the silhouette image (second image). Details of generation of the resized image and the silhouette image, and details of the feature amount extraction processing are similar to the registration processing illustrated in FIG. 2, and therefore, description of the details is omitted. The resolution of the resized image during retrieval is required to be coincident with the resolution of the resized image during the registration processing.

In step S606, the CPU 201 of the image retrieval server 100 calculates a similarity between the retrieval image and the registered image by using the feature amounts of the retrieval image extracted in step S605 and the feature amounts stored in the storage unit 110. To calculate the similarity between the feature amounts, a Euclidean distance, a cosine similarity, or the like can be used. In the present embodiment, an example in which the Euclidean distance is used as a method of evaluating the similarity between the feature amounts is described. It can be determined that the images are more similar to each other as a determined value of the Euclidean distance indicating “similarity between feature amounts” is smaller, whereas it can be determined that the images are less similar to each other as the value of the Euclidean distance is larger.

Next, details of the processing in step S606 are described with reference to a sub-flowchart illustrated in FIG. 7.

In step S701, the CPU 201 of the image retrieval server 100 calculates a distance indicating a similarity between the feature amount of the resized image extracted in step S605 and the feature amount of the resized image stored in the resized image feature amount storage unit 111 (distance calculation processing). The calculation of the distance is performed on each of the feature amounts of the resized images registered in the storage unit 110, namely, all the resized images previously subjected to the registration processing.

In step S702, the CPU 201 of the image retrieval server 100 performs weighting (weight adding) processing to the distance calculated in step S701.

In step S711, the CPU 201 of the image retrieval server 100 determines a distance between the feature amount of the silhouette image extracted in step S605 and the feature amount of the silhouette image stored in the silhouette image feature amount storage unit 112. The calculation of the distance is performed on each of the feature amounts of the silhouette images registered in the storage unit 110, namely, all the silhouette images previously subjected to the registration processing.

In step S712, the CPU 201 of the image retrieval server 100 performs weighting (weight adding) processing on the distance calculated in step S711.

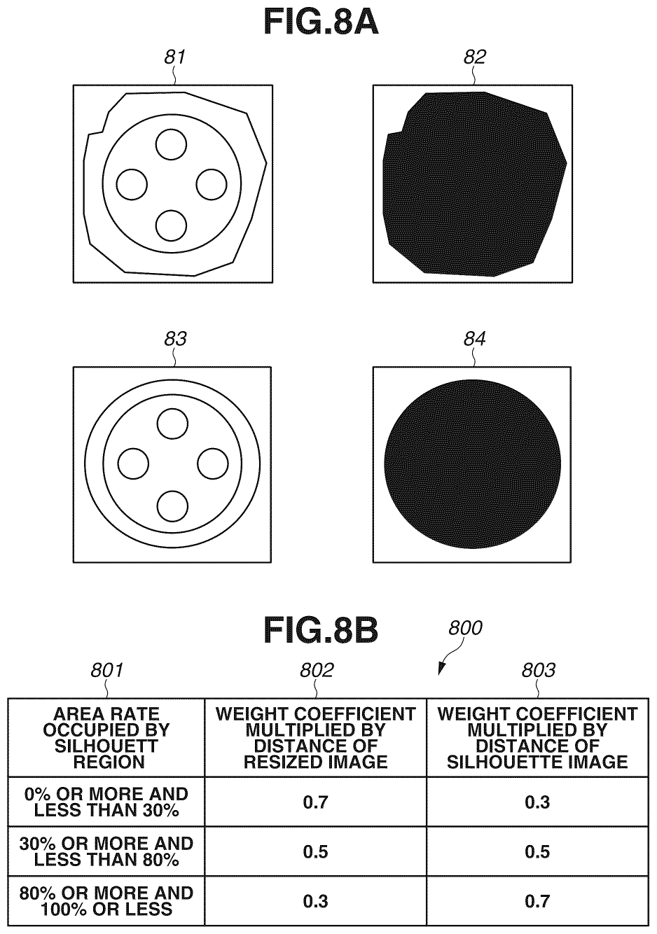

Details of the weighting processing performed in step S702 and step S712 are described. In the present embodiment, to correctly determine the concave and convex parts even from the image drawn only by lines, the feature amount is extracted from the silhouette image. Depending on the shapes of the lines, there is a case where it is necessary to prioritize the feature amount of the resized image rather than the feature amount of the silhouette image for determination of the similarity. Such an example is described with reference to FIG. 8A. FIG. 8A illustrates a resized image 81 generated from the registered image during the registration, a silhouette image 82 generated from the same registered image, a resized image 83 generated from the retrieval image, and a silhouette image 84 generated from the same retrieval image. An internal shape of the resized image 81 and an internal shape of the resized image 83 are similar to each other, but an outer shape of the silhouette image 82 and an outer shape of the silhouette image 84 are different from each other. For this reason, when the feature amount of the silhouette image is prioritized, the retrieval image is unlikely determined to be similar to the registered image.

Accordingly, it is possible to focus on an area of the silhouette image and complexity of the resized image, and to determine whether to prioritize the feature amount of the resized image or the feature amount of the silhouette image based on a situation. In other words, by multiplying the similarity calculated from the feature amount by a weight coefficient corresponding to shape characteristics of the retrieval image, adjustment is performed such that influence of the image to be prioritized becomes large in similarity determination.

More specifically, the adjustment can be performed by preparing a data table 800 for determining the weight characteristics as illustrated in FIG. 8B in the storage unit 110 or the like. The data table 800 includes an area rate 801 occupied by the silhouette region, a weight coefficient 802 to be multiplied by the distance of the resized image, and a weight coefficient 803 to be multiplied by the distance of the silhouette image. The silhouette region indicates a painted region of the silhouette image generated from the retrieval image in step S607, and the silhouette area rate indicates a rate of an area of the silhouette region to a whole area.

The reason why the weight coefficients are determined based on the area of the silhouette is because, when the rate occupied by the silhouette region is large in the silhouette image, features due to a silhouette outermost contour are poor, and there is a high possibility that the resized image is more important as the features. For this reason, in the example of the data table 800, when the silhouette area rate is small, the weight coefficient of the resized image is set large. In contrast, when the silhouette area rate is large, the weight coefficient of the silhouette image is set large. In other words, as the silhouette area rate is increased, the weight coefficient of the resized image is reduced and the weight coefficient of the silhouette image is increased.

By adding a weight to the distance based on the area of the silhouette image during distance calculation using the resized image and the silhouette image, it is possible to improve retrieval accuracy. The retrieval accuracy in the case where the silhouette image is used and the retrieval accuracy in the case where the silhouette image is not used are evaluated using an average relevance ratio. As a result, the retrieval accuracy can be improved by 10% by using the silhouette image, and the retrieval accuracy can be further improved by 13% by using the weights based on the area.

In other words, in step S702, the CPU 201 of the image retrieval server 100 determines the silhouette area rate based on the silhouette image of the retrieval image, and determines the weight coefficients by referring to the data table 800 based on the area rate. Further, the CPU 201 of the image retrieval server 100 multiplies the distance determined from the feature amount of the resized image by the weight coefficient 802 for the resized image, to calculate the adjusted distance.

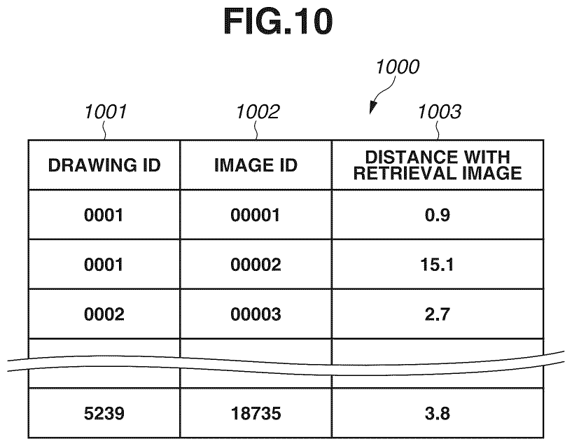

The calculated adjusted distance can be temporarily stored in the storage unit by using a data table 1000 as illustrated in FIG. 10. The data table 1000 includes a drawing ID 1001 of the registered drawing, an image ID 1002 of the registered image, and a distance 1003 between the registered image and the retrieval image. The drawing ID 1001 indicates a unique number of each registered drawing, the image ID 1002 indicates a unique number of each registered image, and the distance 1003 with the retrieval image is the adjusted distance determined by weighting the distance calculated from the feature amount of the retrieval image and the feature amount of the resized image with the weight coefficient.

Likewise, in step S712, the adjusted distance is calculated by multiplying the distance determined from the feature amount of the silhouette image by the weight coefficient 803 for the silhouette image. The adjusted distance calculated for the silhouette image can also be temporarily stored by using a data table similar to the data table illustrated in FIG. 10. In step S703, the CPU 201 of the image retrieval server 100 adds the adjusted distance for the resized image and the adjusted distance for the silhouette image, to calculate a total distance of each of all the registered images subjected to the registration processing. At this time, not only addition but also multiplication may be used as the calculation method. The total distance indicates the similarity between the retrieval image and the registered image, and the registered image having the shortest total distance is an image most similar to the retrieval image.

In a case where a plurality of retrieval images is acquired in step S603, the processing in steps S604 to S606 is repeatedly performed by the number of retrieval images.

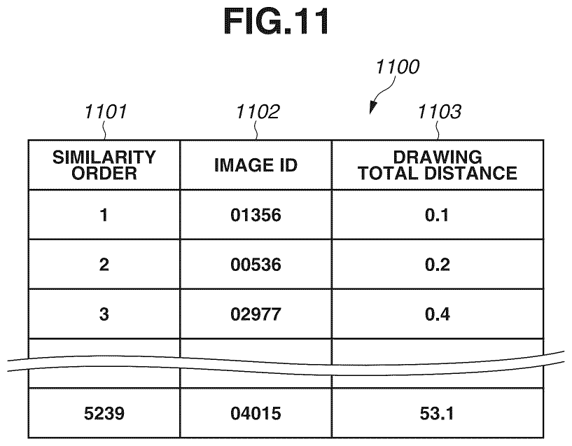

In step S607, the CPU 201 of the image retrieval server 100 adds, for each drawing ID of the registered drawing, distances between the plurality of retrieval images included in the retrieval drawing and the respective most similar registered images among the registered images included in the drawing having the drawing ID, to calculate a drawing total distance. Thereafter, the CPU 201 of the image retrieval server 100 transmits the calculation result to the client terminal 10. In other words, the CPU 201 of the image retrieval server 100 calculates the similarity with the retrieval drawing for each drawing ID of the registered drawing. FIG. 11 illustrates an example of a data table 1100 in which the distances are sorted in descending order of similarity (similarity order) based on the calculated similarities. The data table 1100 includes a similarity order 1101, a drawing ID 1102 of the registered drawing, and a drawing total distance 1103.

In step S609, the CPU 201 of the client terminal 10 receives the similarity retrieval result from the image retrieval server 100, and displays the similarity retrieval result on a display terminal such as the display 210. As a display method, the data table 1100 for enabling determination of the similarity as illustrated in FIG. 11 may be displayed, or the registered drawings may be displayed in the similarity order.

In step S610, the CPU 201 of the client terminal 10 receives designation from the user on the display terminal displaying information for enabling determination of the similarity. In step S611, the CPU 201 of the client terminal 10 displays detailed information on the designated registered drawing on the display terminal. The CPU 201 of the client terminal 10 may acquire the detailed information from the drawing DB 120 and display the detailed information.

The CPU 201 of the client terminal 10 may display the registered drawing having the highest similarity on the display terminal of the client terminal 10 without receiving designation from the user. In the present embodiment, the example in which the similar drawing is displayed as the retrieval result is described, but the registered image similar to each retrieval image may be displayed.

FIG. 12B illustrates an example in which the registered drawings are displayed in the similarity order on a display screen 1210. Displayed registered drawing data 1211 includes an image of a registered drawing 1212, information 1213 in the data table 1100, and a display button 1214 for designating the registered drawing 1212. When the display button 1214 is pressed, designation from the user is received, and the registered drawing data 1211 and the detailed information are enlarged and displayed.

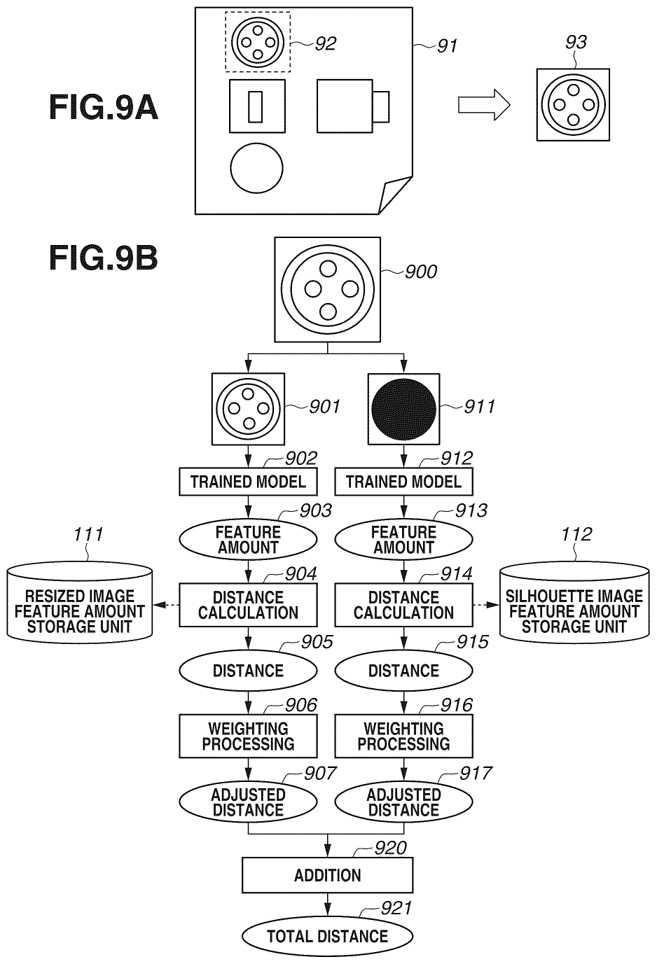

Next, a flow of the similarity calculation processing performed in steps S604 to S606 is described with reference to FIG. 9B. A resized image 901 is an image obtained by resizing a retrieval image 900 to have a resolution of 224×224 pixels. A silhouette image 911 is a silhouette image obtained by resizing the retrieval image 900 to have a resolution of 224×224 pixels while keeping the aspect ratio of the retrieval image 900, and painting the inside of the outermost contour. The feature amounts can be extracted using trained models 902 and 912. As the trained models to be used, a well-known neural network in which convolutional neural networks (CNNs) are stacked, such as VGG16 and ResNet can be used. In extraction of the feature amounts, it is necessary to use the same trained models as the trained models used in the registration processing.

A feature amount 903 extracted from the resized image 901 and a feature amount 913 extracted from the silhouette image 911 are values respectively output from the trained models 902 and 912, and are output as, for example, one-dimensional numerical arrays. A value of the feature amount of the resized image and a value of the feature amount of the silhouette image can be separately registered. As in the case where the feature amounts are extracted from the registered image, it is necessary to set the array of the feature amount of the resized image determined from the retrieval image to 1024, and to set the array of the feature amount of the silhouette image to 512.

In step S701, a distance 905 indicating a similarity between the feature amount 903 of the resized image and the feature amount of the resized image stored in the resized image feature amount storage unit 111 is calculated. Further, in step S702, weighting processing is performed on the distance 905 to calculate an adjusted distance 907.

In step S711, a distance 915 indicating a similarity between the feature amount 913 of the silhouette image and the feature amount of the silhouette image stored in the silhouette image feature amount storage unit 112 is calculated. Further, in step S712, weighting processing is performed on the distance 915 to calculate an adjusted distance 917.

The distance calculation processing using the feature amounts takes a time as the number of images registered in the storage unit 110 is increased. Accordingly, to accelerate calculation, an approximate nearest neighbor search algorithm can be used.

Thereafter, the adjusted distance 907 for the resized image and the adjusted distance 917 for the silhouette image are added to calculate a total distance 921 for each of all registered images subjected to the registration processing. In the present embodiment, a form in which the weighting processing is performed on both the feature amount of the silhouette image and the feature amount of the resized image is described, but the weighting processing may be performed on one of the silhouette image and the resized image.

By using the above-described mechanism, it is possible to retrieve a drawing/image similar to the retrieval drawing/retrieval image with high reliability, from the registered drawings/registered images in the drawing DB already generated and stored.

### Second Embodiment

In the first embodiment, the method in which the weight coefficients are determined based on the area of the silhouette image, and the distances are weighted with the weight coefficients to improve the retrieval accuracy is described. In a second embodiment, a method in which the weight coefficients corresponding to an internal shape of the resized image is determined by focusing on a complexity of the internal shape of the resized image in place of the area of the silhouette image, and the distances are weighted with the weight coefficients to improve the retrieval accuracy is described. In the following description, differences from the first embodiment are mainly described.

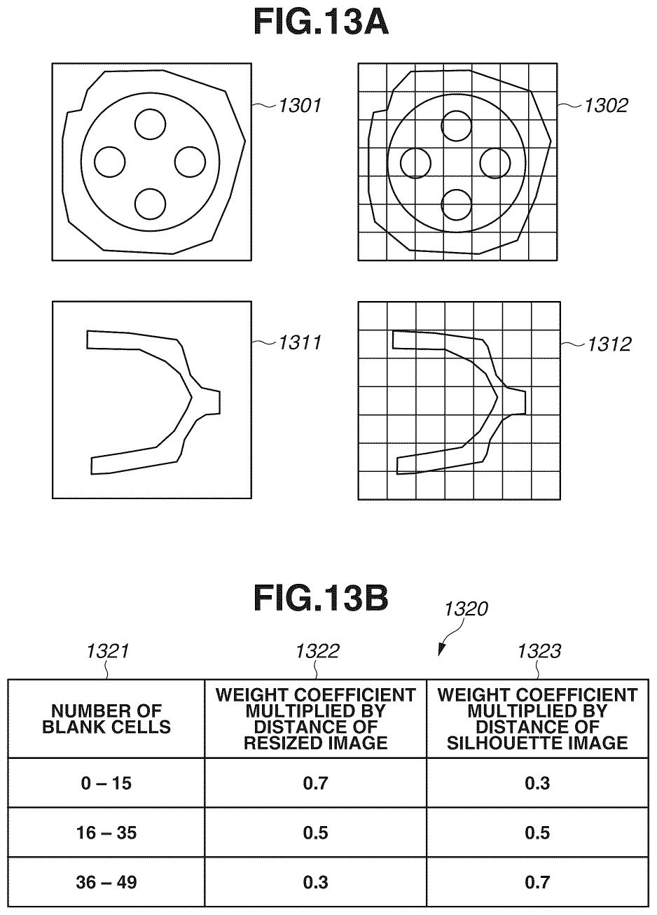

FIG. 13A illustrates an example of a resized image that has a complicated internal shape and has a resolution of 224×224 pixels, generated from the retrieval image. An image 1302 is an image obtained by dividing a resized image 1301 by a grid of 32×32 pixels. The weight coefficients can be determined based on the number of cells of the grid including a line shape of the resized image. In an example of an image 1302 illustrated in FIG. 13A, the number of blank cells of the grid not including the linear shape of the resized image is three. An image 1312 is an image obtained by dividing a resized image 1311 by a grid of 32×32 pixels. In an example of the image 1312, the number of blank cells of the grid not including the line shape of the resized image is 31.

The inside of the resized image is more important as the number of blank cells of the grid is smaller. Therefore, the weight coefficient multiplied by the feature amount of the resized image is set larger as the number of blank cells of the grid is smaller. On the other hand, the weight coefficient multiplied by the feature amount of the silhouette image is set smaller as the number of blank cells of the grid is smaller. Such weight coefficients can be prepared as a data table 1320 as illustrated in FIG. 13B in the storage unit 110 or the like.

The data table 1320 includes the number of blank cells of the grid 1321, a weight coefficient 1322 to be multiplied by the distance of the resized image, and a weight coefficient 1323 to be multiplied by the distance of the silhouette image.

In the example of the image 1301, since the number of blank cells of the grid is three, it is found from the data table 1320 that the weight coefficient to be multiplied by the distance of the resized image is 0.7, and the weight coefficient to be multiplied by the distance of the silhouette image is 0.3. In the example of the image 1311, since the number of blank cells of the grid is 31, it is found that the weight coefficient to be multiplied by the distance of the resized image is 0.5, and the weight coefficient to be multiplied by the distance of the silhouette image is 0.5.

The weighting processing in steps S702 and S712 illustrated in FIG. 7 is performed using the weight coefficients calculated in the above-described manner. The other processing is similar to the processing in the first embodiment, and therefore, description of the processing is omitted.

By using the weight coefficients according to the present embodiment, it is also possible to retrieve a drawing/image similar to the retrieval drawing/retrieval image with high reliability, from the registered drawings/registered images in the drawing DB.

### Modification of Second Embodiment

In the second embodiment, the weight coefficients are determined based on the number of cells of the grid including the line shape of the resized image, but the weight coefficients may be determined by focusing on a length of a line segment of the line shape of the resized image. When the length of the line segment of the resized image is long, the inside of the image is complicated, and the inside image of the resized image is important. For this reason, the weight coefficient to be multiplied by the feature amount of the resized image is set larger as the length of the line segment is longer. On the other hand, the weight coefficient to be multiplied by the feature amount of the silhouette image is set smaller as the length of the line segment is longer. The weighting processing in steps S702 and S712 illustrated in FIG. 7 is performed using the weight coefficients set in the above-described manner. The other processing is similar to the processing in the first embodiment, and therefore, description of the processing is omitted.

By using the weight coefficients according to the present modification, it is also possible to retrieve a drawing/image similar to the retrieval drawing/retrieval image with high reliability, from the registered drawings/registered images in the drawing DB.

The present disclosure using the above-described embodiments can be implemented as, for example, a system, an apparatus, a method, a program, or a storage medium. More specifically, the present disclosure using the above-described embodiments may be applied to a system including a plurality of apparatuses, or may be applied to a single apparatus.

### SUMMARY OF EMBODIMENTS

The disclosure of the present embodiments includes the following configurations.

### Item 1

An information processing system including:
an acquisition unit configured to acquire a first image generated from a retrieval image and a second image as a silhouette image generated from the retrieval image; and
a calculation unit configured to calculate a similarity between the retrieval image and each of a plurality of registered images by comparing the first image and the second image acquired by the acquisition unit with each of the plurality of registered images.

### Item 2

The information processing system according to item 1, in which the similarity is calculated based on a similarity between the first image and each of the plurality of registered images and a similarity between the second image and each of the plurality of registered images.

### Item 3

The information processing system according to item 1 or 2, in which the first image is an image obtained by resizing the retrieval image to have a predetermined size.

### Item 4

The information processing system according to item 3, in which the first image is an image resized at magnifications different between a vertical direction and a horizontal direction.

### Item 5

The information processing system according to any one of items 1 to 4,
in which the retrieval image is an image designated by a user from a retrieval drawing, and
in which the calculation unit calculates a similarity of a registered drawing similar to the retrieval drawing.

### Item 6

The information processing system according to any one of items 2 to 5,
in which the similarity between the first image and each of the plurality of registered images is calculated based on a feature amount extracted from the first image and a previously-stored feature amount corresponding to each of the plurality of registered images, and
in which the similarity between the second image and each of the plurality of registered images is calculated based on a feature amount extracted from the second image and a previously-stored feature amount corresponding to each of the plurality of registered images.

### Item 7

The information processing system according to item 6, in which the similarity between the first image and each of the plurality of registered images is calculated based on a value obtained by weighting a similarity determined from the feature amount extracted from the first image and the previously-stored feature amount corresponding to each of the plurality of registered images.

### Item 8

The information processing system according to item 6 or 7, in which the similarity between the second image and each of the plurality of registered images is specified based on a value obtained by weighting a similarity determined from the feature amount extracted from the first image and the previously-stored feature amount corresponding to each of the plurality of registered images.

### Item 9

The information processing system according to item 8, in which the weighting is performed using a weight coefficient determined by the second image.

### Item 10

The information processing system according to item 8, in which the weighting is performed using a weight coefficient determined by the first image.

### Item 11

The information processing system according to any one of items 1 to 10, in which the silhouette image is an image generated by painting an inside of an outermost contour included in the retrieval image.

### Item 12

A method of controlling an information processing system to perform:
acquiring a first image generated from a retrieval image and a second image as a silhouette image generated from the retrieval image; and
calculating a similarity between the retrieval image and each of a plurality of registered images by comparing the acquired first image and the acquired second image with each of the plurality of registered images.

### Item 13

A program executable by an information processing system, the program causing the information processing system to function as:
an acquisition unit configured to acquire a first image generated from a retrieval image and a second image as a silhouette image generated from the retrieval image; and
a determination unit configured to determine a similarity between the retrieval image and each of a plurality of registered images by comparing the first image and the second image acquired by the acquisition unit with each of the plurality of registered images.

### Item 14

A recording medium storing the program according to item 13, readable by the information processing system.

According to the present disclosure, it is possible to provide the high-reliability similar image retrieval method that enables retrieval of a similar image even when an image has a contour shape drawn by lines.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-190749, filed Oct. 30, 2024, which is hereby incorporated by reference herein in its entirety.

What is claimed is:

1. An information processing system comprising:
an acquisition unit configured to acquire a first image generated from a retrieval image and a second image as a silhouette image generated from the retrieval image; and
a calculation unit configured to calculate a similarity between the retrieval image and each of a plurality of registered images by comparing the first image and the second image acquired by the acquisition unit with each of the plurality of registered images.

2. The information processing system according to claim 1, wherein the first image is an image obtained by resizing the retrieval image to have a predetermined size.

3. The information processing system according to claim 2, wherein the first image is an image resized at magnifications different between a vertical direction and a horizontal direction.

4. The information processing system according to claim 1,
wherein the retrieval image is an image designated by a user from a retrieval drawing, and
wherein the calculation unit calculates a similarity of a registered drawing similar to the retrieval drawing.

5. The information processing system according to claim 1, wherein the similarity is determined based on a similarity between the first image and each of the plurality of registered images and a similarity between the second image and each of the plurality of registered images.

6. The information processing system according to claim 5,
wherein the similarity between the first image and each of the plurality of registered images is calculated based on a feature amount extracted from the first image and a previously-stored feature amount corresponding to each of the plurality of registered images, and
wherein the similarity between the second image and each of the plurality of registered images is calculated based on a feature amount extracted from the second image and a previously-stored feature amount corresponding to each of the plurality of registered images.

7. The information processing system according to claim 6, wherein the similarity between the first image and each of the plurality of registered images is calculated based on a value obtained by weighting a similarity determined from the feature amount extracted from the first image and the previously-stored feature amount corresponding to each of the plurality of registered images.

8. The information processing system according to claim 6, wherein the similarity between the second image and each of the plurality of registered images is specified based on a value obtained by weighting a similarity determined from the feature amount extracted from the first image and the previously-stored feature amount corresponding to each of the plurality of registered images.

9. The information processing system according to claim 8, wherein the weighting is performed using a weight coefficient determined by the second image.

10. The information processing system according to claim 8, wherein the weighting is performed using a weight coefficient determined by the first image.

11. The information processing system according to claim 1, wherein the silhouette image is an image generated by painting an inside of an outermost contour included in the retrieval image.

12. A method of controlling an information processing system to perform:
acquiring a first image generated from a retrieval image and a second image as a silhouette image generated from the retrieval image; and
calculating a similarity between the retrieval image and each of a plurality of registered images by comparing the acquired first image and the acquired second image with each of the plurality of registered images.

13. A non-transitory computer-readable recording medium storing a program readable and executable by an information processing system, the program configured to cause the information processing system to:
acquire a first image generated from a retrieval image and a second image as a silhouette image generated from the retrieval image; and
calculate a similarity between the retrieval image and each of a plurality of registered images by comparing the first image and the second image with each of the plurality of registered images.
